(19) United States
(12) Patent Application Publication
(10) Pub. No.: US 2006/0130326 A1
(43) Pub. Date: Jun. 22, 2006

(54) Engine service tool

(76) Inventors: Edward B. Rigby, Lowell, IN (US); Kevin L. Yost, Glen Ellyn, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/015,453

(22) Filed: Dec. 17, 2004

(51) Int. Cl. B21K 1/22; B23P 19/04

(52) U.S. Cl. 29/888.42; 29/215

(57) ABSTRACT

A tool for an internal combustion engine having a plate (419) capable of causing compressive force to be applied to at least one engine valve spring (125), a fastener (505) operably connected to the plate (419) and a support (401), operably connected to the plate (419) and capable of connecting to an engine component.

### FIELD OF THE INVENTION

This invention relates to service tools and methods for use with internal combustion engines, including but not limited to, a method and apparatus for servicing a valve train.

### BACKGROUND OF THE INVENTION

The process of servicing an internal combustion engine includes the replacement of components. The time consumed and effort expended in component replacement is an expense for the service provider. The process of component replacement varies according to each component on the engine, with the size and accessibility of the component dictating the time and effort it will take to remove it from the engine and install a replacement. Usually, accessibility of the component to be replaces plays a major role in the expense for replacement by a service provider.

Accessibility of service for engine components is affected my many factors. Two main factors are (1) the size and fastening on the component to the engine and (2) the components of the engine that are adjacent to the component to be replaced. Oftentimes, components adjacent to the component being replaced need to be removed to provide access to the component being replaced.

Accordingly, there is a need for avoiding the extra time and added complexity of servicing the valve train components of an internal combustion engine.

### SUMMARY OF THE INVENTION

A tool for an internal combustion engine having a plate capable of causing compressive force to be applied to at least one engine valve spring, a fastener operably connected to the plate and a support, operably connected to the plate and capable of connecting to an engine component.

### BRIEF DESCRIPTION OF THE DRAWINGS

FIG. 1 is a prior art representation of valve train components for an internal combustion engine.

FIG. 2 is a prior art representation of a valve arrangement for an engine having multiple valves per cylinder.

FIG. 3 is a close-in view of a prior art representation of a valve arrangement for an engine having multiple valves per cylinder.

FIG. 4A is a perspective view of a support for a tool in accordance with the invention.

FIG. 4B is a perspective view of a support and clamp with bolt assembly for a tool in accordance with the invention.

FIG. 4C is a perspective view of a plate for a tool in accordance with the invention.

FIG. 5A is perspective view of a support and clamp for a tool installed on an engine in accordance with the invention.

FIG. 5B is a perspective view of a tool installed on an engine in accordance with the invention.

FIG. 6 is a flowchart of a method of utilizing a tool in accordance with the invention.

### DESCRIPTION OF A PREFERRED EMBODIMENT

The following describes an apparatus for and method of servicing a valve train of an internal combustion engine, by compressing a valve spring to facilitate replacement of a rocker arm without removal of a pivot foot or other engine component.

A typical internal combustion engine runs on a 4-stroke cycle. A typical 4-stroke operation consists of an intake stroke, when air and fuel are input to a cylinder, a compression stroke, where a piston compresses the air and fuel mixture, an ignition stroke, where the air and fuel mixture is combusted, and an exhaust stroke, where the exhaust gases produced by the combustion are expelled from the cylinder. Each cylinder of the engine has at least one intake and one exhaust valve.

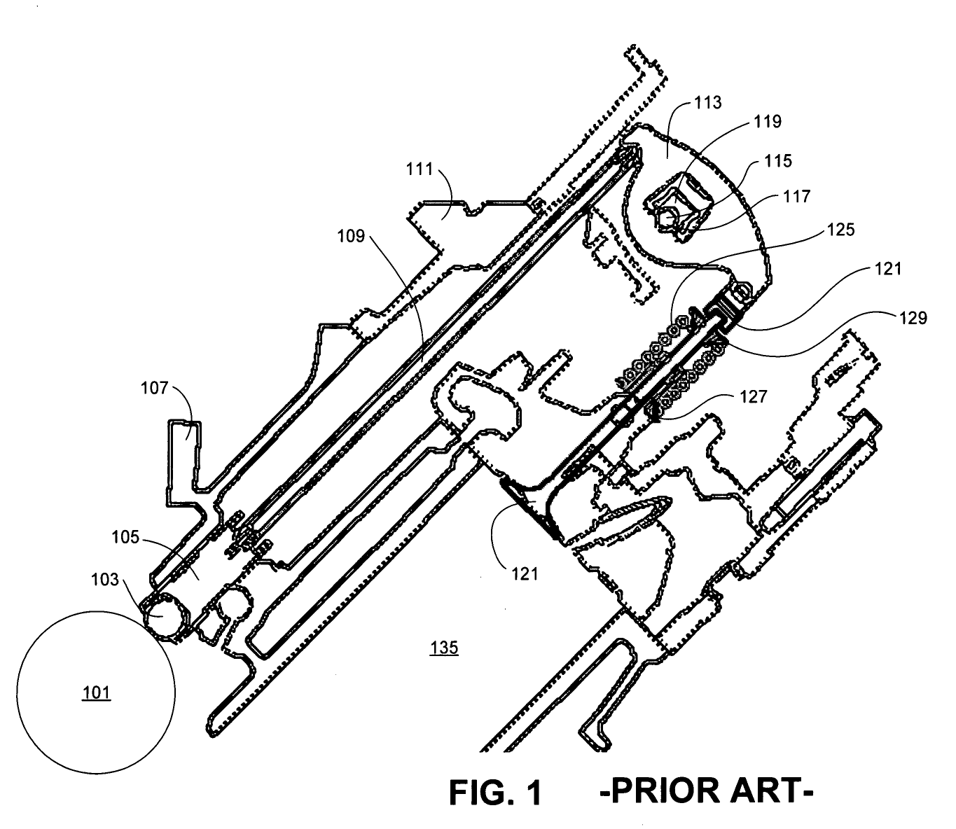

During engine operation, a rotating rod with eccentric cylindrical sections, commonly referred to as a camshaft, is driven by the engine to provide a timing motion to the engine's intake and exhaust valves. A typical valve train for an internal combustion engine is shown in FIG. 1. A camshaft 101 is shown in section. A roller 103 is in constant contact with the outer periphery of a particular section of the camshaft 101, and is constrained to move axially. As the camshaft 101 rotates, it imparts an axial reciprocating motion to the roller 103. The roller 103 is typically rotatably mounted onto a lifter 105. The lifter 105 is installed into crankcase 107 (shown in section) and restrained in axial motion along the centerline of the lifter 105.

The lifter 105 is operably connected to a pushrod 109. The pushrod 109 is transfers reciprocal motion from the lifter 105 to intake and exhaust valves of the engine. The pushrod 109 extends through the crankcase 107, through a cylinder head 111, and up to a rocker arm 113. The rocker arm 113 is pivotally mounted to the engine. The connection between the pushrod 109 and the rocker arm 111 is appropriate to allow translation of the reciprocating motion of the pushrod 109 to a pivoting motion of the rocker arm 113. The rocker arm 113 pivots about a rocker arm pivot point 115. Typically, the pivot point 115 is the center point of a spherical bearing 117. The spherical bearing 117 is located between the rocker arm 113 and a pivot foot 119 (shown in section). The pivot foot 119 is typically mounted to the cylinder head 111.

The pivoting motion of the rocker arm 113 is translated back to an axial reciprocating motion and imparted on an optional valve bridge 121 (shown in section). The valve bridge 121 is in contact with a valve stem 123. A valve spring 125 is disposed around the valve stem 123, and is retained in place by a lower retainer 127 and a spring retainer 129 on the top. The valve stem 123 is an elongated, typically cylindrical bar. At one end, the valve stem is in contact with the valve bridge 121 as discussed above. On an opposite end, the valve stem is either connected to or integrated with a valve member 131. The valve member 131 seals either air from entering a cylinder 135 (shown in section) or exhaust gas from exiting the cylinder 135. Each engine cylinder 135 has at least one valve dedicated to intake air into the cylinder 135, and one valve dedicated to exhaust gas from the cylinder 135.

During engine operation, the camshaft 101 rotates and pushes the roller 130 to move, and the motion of the roller 130 transfers axially through the pushrod 109, pivotally through the rocker arm 113, and axially through the valve stem 123 to unseat and open the valve member 131. As the camshaft 101 continues to rotate, the roller 130 is retracts. The force causing the roller 103 to retract and remain in contact with the camshaft 101 comes from the valve spring 125. When the valve member 131 is unseated, the valve spring 125 is compressed and applying a spring return force onto the rocker arm 113. While the roller 130 is allowed to retract, the retracting axial motion of the roller 103 is translated back to the valve stem 123 and causes the valve spring 125 to extend.

Because the valve spring 125 is relied upon for closing the valve member 131 and maintaining contact between the roller 103 and the camshaft 101, the valve spring 125 is installed with a force, such as a preload. The force on the valve spring 125 provides a continuous closing force on the valve member 131, and a continuous contact force between the roller 103 and the camshaft 101, regardless of orientation of the camshaft 101 in the engine. The force also provides that the rocker arm 113 is always under a loaded condition and not free to rattle during engine operation.

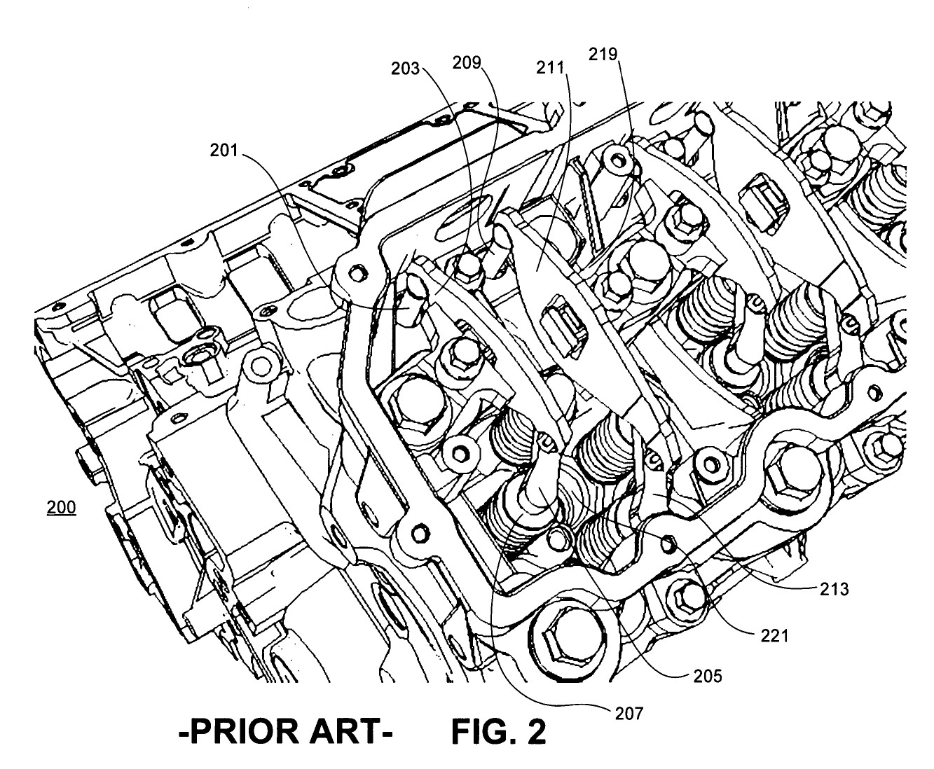

Modern internal combustion engines utilize multiple valves per cylinders. A typical engine having two intake and two exhaust valves for a single cylinder is shown in FIG. 2. The upper portion of an intake pushrod 201 is shown as it protrudes out from the engine 200. The intake pushrod 201 is connected to an intake rocker arm 203, which in turn is connected to an intake valve bridge 205. The intake valve bridge 205 transfers the motion of the intake rocker arm 203 to more than one intake valve. In the engine 200 shown, each of two intake valves 207 are connected. Each intake valve 207 is shown with the spring and spring retainer only visible.

The upper portion of an exhaust pushrod 209 is shown as it protrudes out from the engine 200. The exhaust pushrod 209 is connected to an exhaust rocker arm 211, which in turn is connected to an exhaust valve bridge 213. The exhaust valve bridge 213 transfers the motion of the exhaust rocker arm 211 to more than one exhaust valve. In the engine 200 shown, each of two exhaust valves 215 are connected. Each intake valve 215 is shown with the spring and spring retainer only visible.

A rocker set 217 of an intake rocker arm 203 and an exhaust rocker arm 211 are installed onto the engine 200 through a fulcrum plate 219. The fulcrum plate 219 is bolted onto the engine 200 and provides pivotal support the rocker set 217. During service or replacement of any component in the valve system, the removal of the fulcrum plate 219 is typically required to relieve the force acting on the rocker set 217 through the force on each of the valve springs 125 on the rocker set 217.

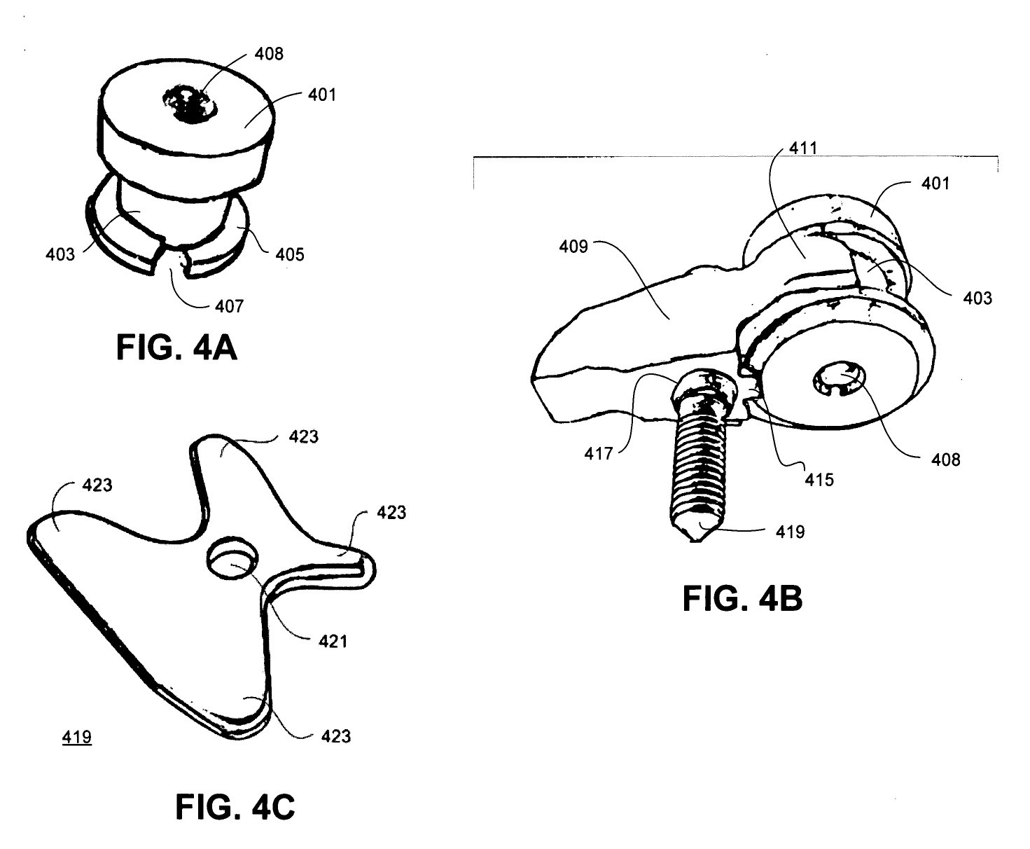

The removal of an intake rocker arm 203 or an exhaust rocker arm 211 from an engine 200, without the prior removal of a fulcrum plate 219 may be accomplished by a tool, the components of which are shown in FIG. 4A, FIG. 4B and FIG. 4C. The tool relieves the force acting on the rocker set 217 and facilitates removal of valve train components, such as rocker arms, without the need to remove the fulcrum plate 219. The support 401 is shown in FIG. 4A. In the embodiment shown, the support 401 acts like a base for the installation of the tool. The support 401 has a substantially cylindrical shape that advantageously mimics the shape of a section of an injector installed on the engine 200. The support 401 has an undercut 403 that forms a lower ledge 405 having a notch 407, and an inner bore 413. The support 401 has a threaded mounting hole 408 running substantially along the centerline of support 401.

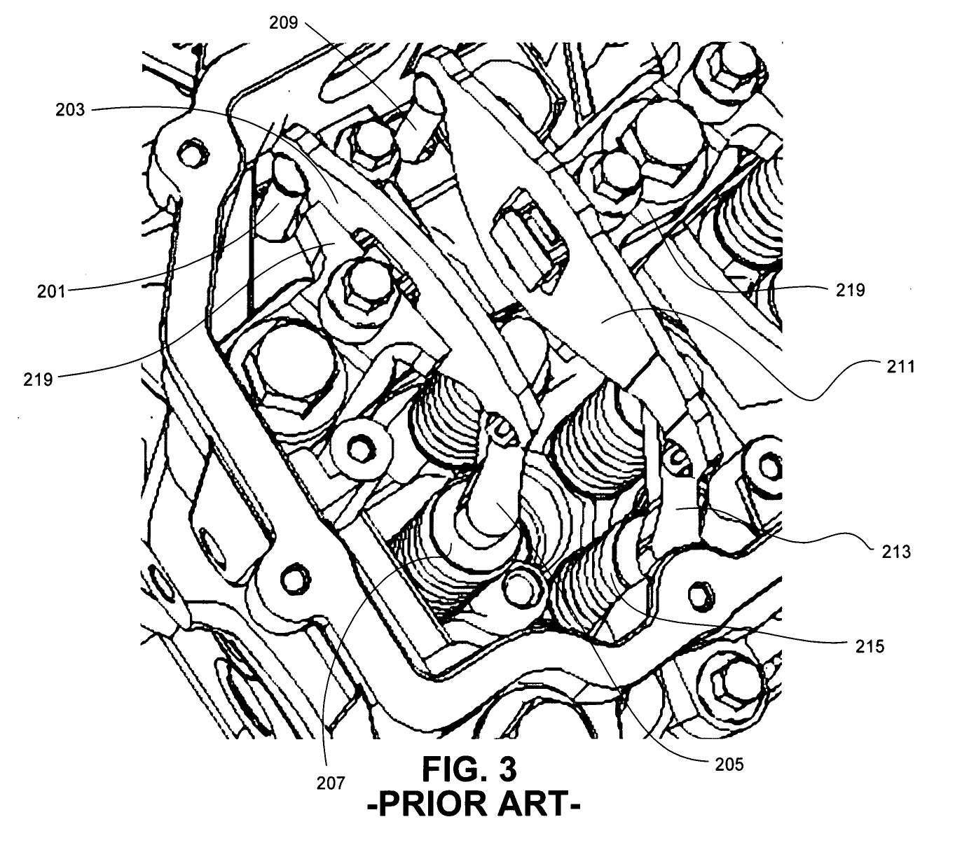

The support 401 is inserted in a bore 221 of the cylinder head 111 that remains once an injector has been removed. Upon installation, the lower ledge 405 of the support 401 is substantially level with an outermost lip of the bore 221. A clamp 409 as shown in FIG. 3B may be used in conjunction with the support 401 for mounting purposes. The clamp 409 has two projections 411 on one end that form a “Y” shape to receive the inner bore 413 of the support 401. The clamp 409 has a protrusion 415, arranged to fit within the notch 407 of the support 401 for alignment and prevention of rotation. The clamp 409 has a through-hole 417 that is arranged to receive a mounting bolt 418. The mounting bolt 418 mounts the clamp 409 and the support 401 onto the engine.

An additional part of the tool is a plate 419 as shown in FIG. 4C. The plate 419 is a flat plate having a clearance hole 421 and four projections 423. Each projection 423 is arranged along the periphery of the plate 419 and is used for making contact with engine components that are in direct or indirect contact with valve springs of the engine. The plate is advantageously made of metal, the projections 423 need not have the same shape, and fewer than four and more than four projections may be utilized. The shape of each projection 423 is advantageously arranged to avoid contact with engine components while the tool is installed.

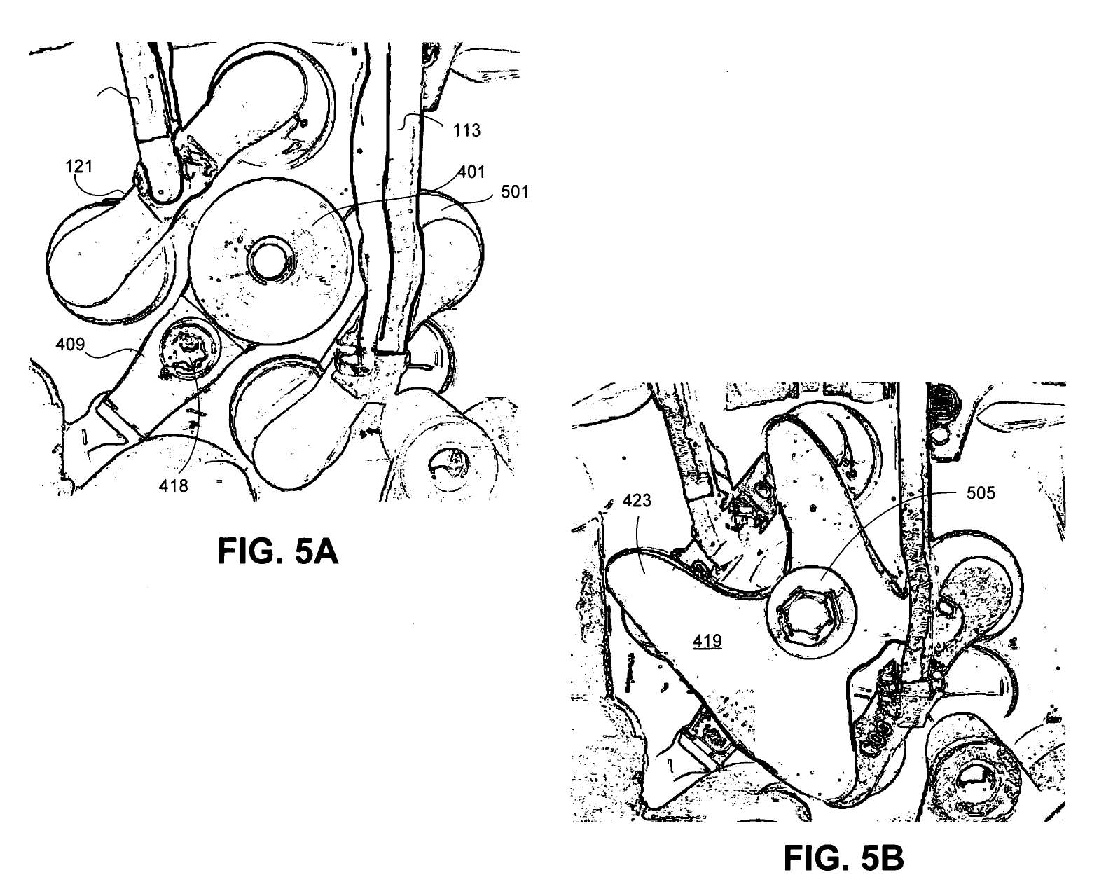

The installation of the tool begins with the removal of a fuel injector from the engine. As shown in FIG. 5A, the support 401 is inserted in the empty bore 221 from the removal of an injector, and the clamp 409 is installed to secure the support 401 by tightening the mounting bolt 418. The clamp 409 may advantageously be the same clamp that was removed from the engine and was used to secure the removed injector to the engine.

Once the installation of the support 401 and clamp 409 is complete, the plate 419 is installed, as shown in FIG. 5B. The plate 419 is installed over the top of the support 401, with each projection 423 extending toward each of four adjacent engine valves 501. In the embodiment shown, each projection 423 makes contact with the top surface 503 of adjacent valve bridges 121. Alternatively, the plate 419 may be arranged to contact each upper spring retainer 129 of the adjacent engine valves 501, or even operably engage the each spring 125 of the adjacent engine valves 501. After the plate 419 is positioned, a fastener such as a bolt 505, is inserted in the through hole 421 of the plate 419 and threaded into the threaded hole 408 of the support 401 below.

With each projection 423 in compressive contact with each adjacent engine valve 501 and the bolt 505 installed, each valve spring 125 may be compressed by driving the plate closer to the support 401 by tightening the bolt 505. After the bolt 505 is sufficiently tight, the plate 419 is sufficiently close to the support 401, and each spring 125 is sufficiently compressed to remove the force that was acting on the rocker arm pivot point 115. With the force removed, it is possible to remove each rocker arm 113, pushrod 109, bearing 117, and/or any combination of components from the engine. The removal of the bridge 121 may also be possible if the plate 419 is removed or alternatively installed and arranged not to make contact with the bridge 121.

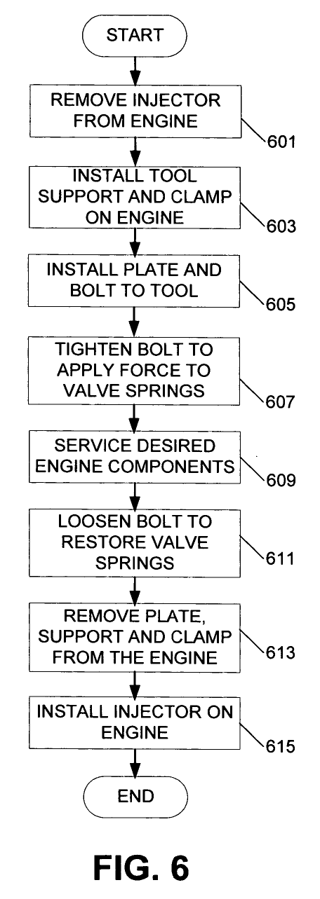

A flowchart illustrating a method of using the tool to service an engine is shown in FIG. 6. An injector is removed at step 601. The support 401 and the clamp 409 are installed at step 603. The clamp 409 is secured to the cylinder head 111 of the engine 200 by a mounting bolt 418. The plate 419 and the bolt 505 are installed at step 605. The bolt 505 is tightened to relieve the force from the pivot point 115 at step 607. Engine components such as a rocker arm 113, a pushrod 109, a bearing 117, and/or a valve bridge 121 may be removed and replaced from the engine at step 609. The bolt 505 is backed out and force is restored on the pivot point 115 at step 611. The support 401 and clamp 409 are removed at step 613, and an injector is installed on the engine 200 at step 615. When service of the engine is complete, the plate 419 and all other components of the tool may be removed in the opposite order by which they were installed, and the components removed from the engine for the installation of the tool may be reinstalled to complete the job.

The use of the tool is advantageous for the service of an engine, because the tool provides a simple way of servicing engine valve-train components without requiring the removal of any other engine components except for an injector. This method of service is advantageous over prior service methods, because the current method eliminates the need to remove the fulcrum plate when servicing a rocker arm, pushrod, bearing, or valve bridge of an engine. Alternative embodiments of this tool may integrate some or all of its components, or mount a plate of the tool or an equivalent plate to a different component of the engine. The functionality of the embodiment described above is substantially accomplished by the ability to compress valve springs on an engine and remove the force acting on a pivot point to enable replacement of parts that would otherwise have required the removal of a fulcrum plate. This invention may also be applied in a similar manner to engines that do not have pushrods, but have instead utilize an overhead camshaft that actuates the engine valves from a position above the engine without the use of a pushrod.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A tool comprising:
a plate capable of causing compressive force to be applied to at least one engine valve spring;
a fastener operably connected to the plate;
a support operably connected to the plate and capable of connecting to an engine component.

2. The tool of claim 1, further comprising a clamp disposed on the engine component and capable of retaining the support.

3. The tool of claim 1, wherein the plate has a plurality of projections, each projection capable of applying at least a part of the compressive force.

4. The tool of claim 1, wherein the fastener is a single threaded fastener.

5. The tool of claim 4, wherein the fastener is capable of controlling a magnitude of the applied compressive force between the plate and the at least one engine valve spring.

6. The tool of claim 1, wherein the support is disposed in an opening for an injector.

7. The tool of claim 6, wherein the engine component is a cylinder head.

8. The tool of claim 7, further comprising a clamp disposed adjacent to the base and secured to the cylinder head with at least one fastener.

9. The tool of claim 1, wherein the plate has at least one projection, the at least one projection shaped to avoid contact with any engine component while the plate is installed on an engine.

10. A method comprising the steps of:
fixing a support to a component of an internal combustion engine;
securing a plate to the support;
compressing at least one engine valve spring with a compressive force from the plate;
removing a first rocker arm from the engine;
installing at least one of the first rocker arm and a second rocker arm on the engine;
decompressing the at least one engine valve spring;
removing the support from the component.

11. The method of claim 10, further comprising the step of removing a first valve bridge from the internal combustion engine.

12. The method of claim 11, further comprising the step of installing at least one of the first valve bridge and a second valve bridge.

13. The method of claim 10, further comprising the step of clamping the support to the component.

14. The method of claim 10, wherein the step of securing the plate to the support is accomplished with a fastener.

15. The method of claim 14, further comprising the step of adjusting a magnitude of the compressive force with the fastener.

16. A method comprising the steps of:
attaching a tool to an internal combustion engine;
using the tool to compress at least one engine valve spring;
relieving a force from a rocker arm pivot point;
replacing at least one of a rocker arm, a pivot foot, and a valve bridge;
decompressing at least one engine valve spring;
applying the force to the rocker arm pivot point;
removing the tool.

17. The method of claim 16, wherein the tool comprises a base and a plate, and wherein the tool is attached to a cylinder head of the internal combustion engine.

18. The method of claim 16, wherein the force in the relieving step is a preload applied to the rocker arm pivot point by the at least one engine valve spring.

19. The method of claim 16, wherein the force in the applying step is a preload applied to the rocker arm pivot point by the at least one engine valve spring.

20. The method of claim 16, further comprising the steps of replacing an injector from the internal combustion engine with the tool and reinstalling the injector to the internal combustion engine.
